(19) United States
(12) Patent Application Publication
(10) Pub. No.: US 2007/0229022 A1
(43) Pub. Date: Oct. 4, 2007

(54) Power-Supply Unit

(75) Inventors: Kiyoshi Hanafusa, Tokyo (JP); Hiroichi Ishida, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Mitsubishi Electric Corporation, Chiyoda-ku (JP)

(21) Appl. No.: 11/576,603

(22) PCT Filed: Dec. 8, 2004
(86) PCT No.: PCT/JP04/18301

§ 371 Date: Apr. 4, 2007

(51) Int. Cl. H02J 7/34

(52) U.S. Cl. 320/101

(57) ABSTRACT

A power-supply unit includes a chargeable secondary battery 1 connected to a load circuit; a fuel cell 4 connected to the secondary battery 1 through a PchFET 5; and a switch-controlling circuit 6 on/off controlling the PchFET 5 according to how large load current is applied to the load circuit and whether the secondary battery 1 is in a charged state or in a discharged state; thus finely controlling power source supply to the load circuit from the secondary battery 1 and the fuel cell 4. The description is given of the case where positive voltage power source is used with respect to the ground. Even in case of negative voltage, a circuit can be configured on the same principle as the positive voltage.

### TECHNICAL FIELD

The present invention relates to a power-supply unit in which a secondary battery and a fuel cell are combined.

### BACKGROUND ART

Conventional power-supply units include a fuel cell generating system generating DC power from a chemical reaction of fuel gas and air and a secondary battery system accumulating therein the DC power generated by the fuel cell generating system converting AC power from a power system to the DC power to accumulate the power when the power of the power system is in excess, and converting the accumulated DC power to the AC power to supply the AC power to the power-supply system when the power from the power system is in short supply (see Patent Document 1, for example)

Patent Document 1. JP-A5-22870

The conventional power-supply unit is arranged as mentioned above. Such an arrangement precludes power source supply from being finely controlled to a load on the power system side from the secondary battery system and the fuel cell generating system.

Moreover, there is a possibility that the secondary battery system may break down due to a ripple of the DC power when converting the AC power of the power-supply system into the DC power and accumulating the converted DC power in the secondary battery system.

Further, there are some cases where the voltage generated by the fuel cell may drop due to an internal impedance of the fuel cell generating system when a heavy load is put on the power system side.

Meanwhile, in a power-supply unit in which a load is an electric vehicle or its equivalent, and the unit solely consumes power while the vehicle is running and is devoid of a faculty of charging the secondary battery, there is need to charge the secondary battery from the fuel cell under a light load.

Furthermore, when the load is a motor vehicle including a gasoline-fueled vehicle, or the likes it requires instantaneous power during starting. For this reason, it needs to install a battery having a large electric capacity as the secondary battery, resulting in the weight being heavy and the volume being large.

The present invention has been made to solve the above-mentioned problems. An object of the present invention is to provide a power-supply unit finely controlling power source supply to the load circuit from the accumulating means and the fuel cell.

### DISCLOSURE OF THE INVENTION

The power-supply unit according to the present invention includes a chargeable accumulating means connected to a load circuit; a fuel cell connected to the accumulating means through a switching circuit; and a switch-controlling circuit on/off controlling the switching circuit according to how large load current is applied to the load circuit and whether the accumulating means is in a charged state or in a discharged state.

This allows finely controlling the power source supply to the load circuit from the accumulating means and the fuel cell according to how large load current is applied to the load circuit and whether the accumulating means is in a charged state or in a discharged state.

Moreover, the power-supply unit dispenses with a power converter converting from a direct current to an alternating current, or vice versa, which prevents a breakdown of the accumulating means caused by a ripple or the like.

Further, even when the load current is large, ON control of the switching circuit provides connection between the fuel cell and the accumulating means, which supplies power generated by the fuel cell to the load circuit, and charges the accumulating means, if circumstances require, thereby saving the time to be taken for charging the accumulating means under a light load.

Furthermore, when the load current is large, ON control of the switching circuit permits supply of the power from both of the fuel cell and the accumulating means, which reduces an electric capacity of the accumulating means.

### BRIEF DESCRIPTION OF THE DRAWINGS

FIG. 1 is a circuit diagram showing a power-supply unit according to the first embodiment of the present invention.

FIG. 2 is a table showing ON/OFF control conditions of the switching circuit.

FIG. 3 is a circuit diagram showing a power-supply unit according to the second embodiment of the present invention.

FIG. 4 is a circuit diagram showing a power-supply unit according to the third embodiment of the present invention.

FIG. 5 is a circuit diagram showing a power-supply unit according to the fourth embodiment of the present invention.

### BEST MODE FOR CARRYING OUT THE INVENTION

Embodiments of the present invention will now be described with reference to the accompanying drawings for describing the present invention in more detail.

### First Embodiment

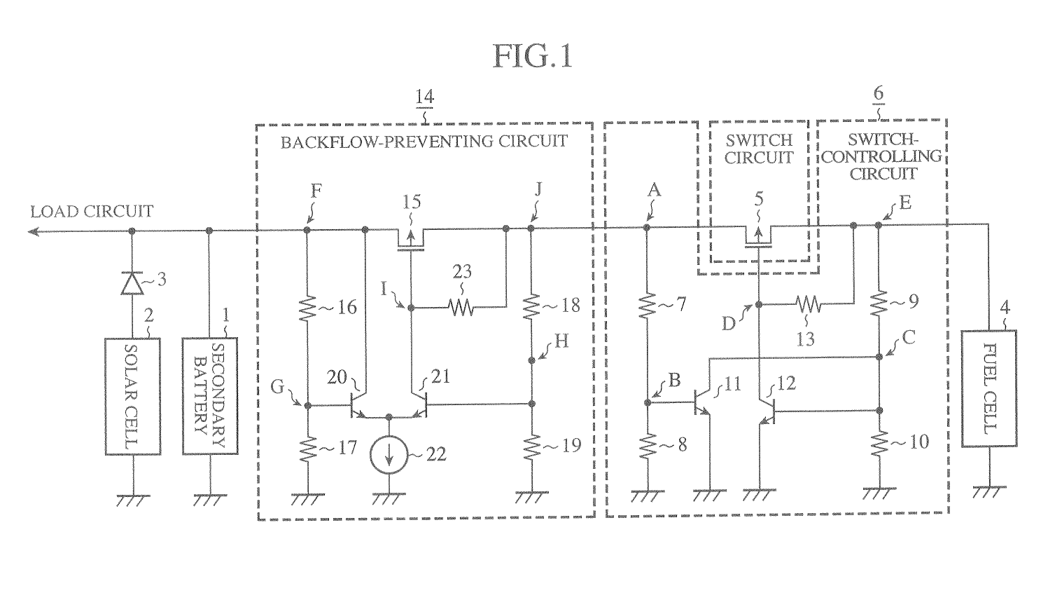

FIG. 1 is a circuit diagram showing a power-supply unit according to the first embodiment of the present invention. Referring to FIG. 1, a secondary battery (accumulating means) 1 is constructed chargeably of one of a lithium-ion battery, a polymer battery a nickel-hydrogen battery, a nickel-cadmium battery, or the like, and is connected to a load circuit. Say in addition, this secondary battery 1 able to accumulate large energy may be a parallel circuit configured by the secondary battery 1 and a capacitor.

A solar cell 2 is connected to the secondary battery 1 and the load circuit through a diode (second backflow-preventing circuit) 3, an anode of which is connected to the solar cell 2 and a cathode of which is connected to the secondary battery 1 side and the load circuit. The diode 3 is for preventing a backflow of current from the secondary battery 1 side or the load circuit side to the solar cell 2.

A fuel cell 4 is connected to the secondary battery 1 side and the load circuit side via a PchFET (switching circuit) 5, and generates DC power by means of a chemical reaction of such fuel as methanol or hydrogen and air. A source of the PchFET 5 is connected to the fuel cell side and a drain thereof is connected to the load circuit side.

A switch-controlling circuit 6 is for on/off controlling the PchFET 5 according to how large load current is supplied to the load circuit and whether the secondary battery 1 is in a charged state or in a discharged state. In this switch-controlling circuit 6, resistors (accumulating-means side voltage-detecting circuits) 7, 8 are for detecting voltage of point A on the secondary battery side rather than the PchFET 5, and dividing the voltage into voltage of point B. Resistors (fuel-cell side voltage-detecting circuits) 9, 10 are for detecting voltage of point E on the fuel cell 4 side rather than the PchFET 5, and dividing the voltage into voltage of point C. A base of a transistor is connected to point B, a collector thereof is connected to point C, and an emitter thereof is connected to the ground, respectively. A base of a transistor 12 is connected to point C, a collector thereof is connected to point D that is a gate of the PchFET 5, and an emitter thereof is connected to the ground, respectively. Further, a resistor 13 is connected between point E and point D.

A backflow-preventing circuit (first backflow-preventing circuit) 14 is for preventing a backflow of current from the secondary battery 1 side or the load circuit side to the fuel cell 4. In the backflow-preventing circuit 14, a source of a PchFET 15 is connected to the fuel cell side and a drain thereof is connected to the load circuit side. Resistors 16, 17 are for detecting voltage of point F on the secondary battery 1 side rather than the PchFET 15, and dividing the voltage into voltage of point G. Resistors 18, 19 are for detecting voltage of point J on the fuel cell 4 side rather than the PchFET 15, and dividing the voltage into voltage of point H. A base of a transistor 20 is connected to point G, a collector thereof is connected to point F, and an emitter thereof is connected to a constant current circuit 22 respectively. A base of a transistor 21 is connected to point H, a collector thereof is connected to point I that is a gate of the PchFET 15 and an emitter thereof is connected to the constant current circuit 22, respectively. The other end of the constant current circuit 22 is connected to the ground. Further, a resistor 23 is connected between point J and point I.

The operation of the first embodiment will now be described below.

The power-supply unit shown in FIG. 1 is arranged such that the secondary battery 1 and solar cell 2, and the fuel cell 4 are disposed in parallel via the PchFET 5, and that power generated by the fuel cell 4 is charged in the secondary battery 1 or is supplied to the load circuit. Arranging in this way, in the switch controlling circuit 6, when the load circuit is under a heavy load, the PchFET 5 is turned on to supply power from both of the fuel cell 4 and the secondary battery 1 to the load circuit, and when the load circuit is under a light load and the secondary battery 1 approaches a fully charged state the PchFET 5 is turned off to stop generation of electricity by the fuel cell 4. Thus, enhance of an energy efficiency can be achieved as the whole system. Even though the load circuit is under a light load, when the secondary battery 1 is in a completely discharged state (the amount of the accumulated power is extremely small), the PchFET 5 is turned on to supply power from the fuel cell 4 to the load circuit and the second battery 1

Here, the details of ON/OFF control conditions of the switching circuit will be described below.

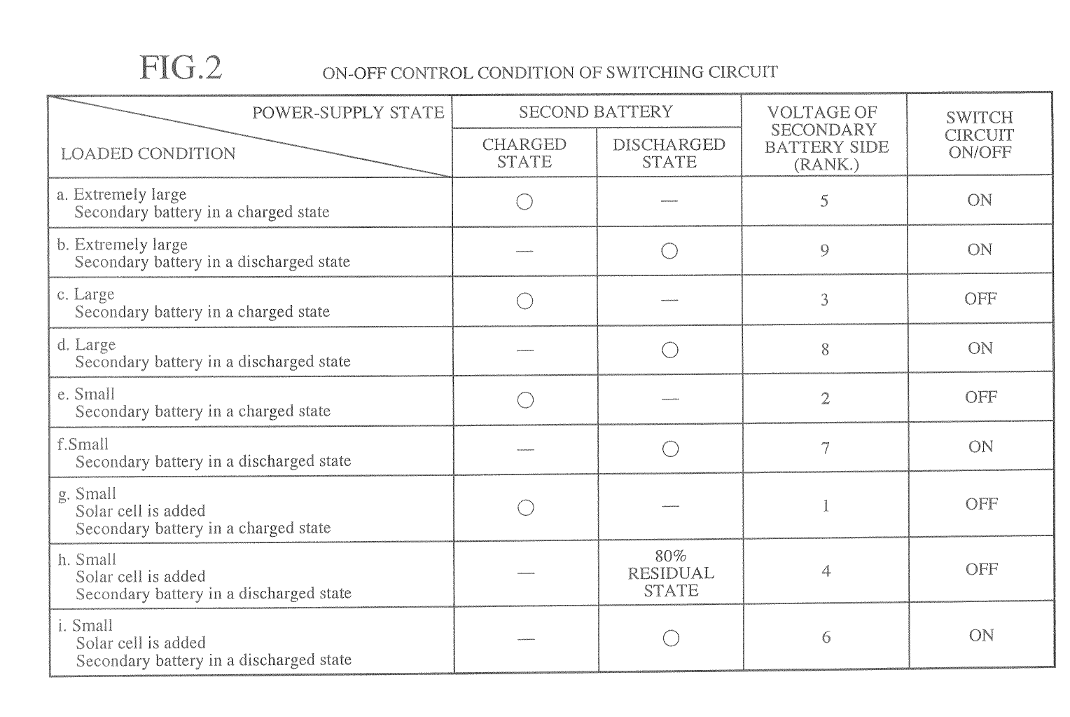

FIG. 2 is a table showing the ON/OFF control conditions of the switching circuit. This switching circuit corresponds to the PchFET 5 shown in FIG. 1, to which a portable telephone is connected. As can be seen at a glance, the table is classified according to circumstances into the case where a load current to the load circuit is extremely large; the case where a load current is large; and the case where a load current is small; as well as into the case where the secondary battery 1 is in a fully charged state and the case where the secondary battery 1 is in a discharged state (the quantity of the accumulated electricity is small). The table shows that either of ON control or OFF control of the switching circuit is to be done. Moreover, voltages of the secondary battery 1 side, shown in FIG. 2, are those in each condition, i.e., expected voltages at point A shown in FIG. 1, which are numbered by 1 to 9 in descending order of voltage (numbering is given to voltages at point A by 1 to 9 in descending order of voltage. However, since the generated voltage changes depending on a value of the load current, a charged state, capacity, and an internal impedance of the secondary battery, and the amount of light received by the solar cell, FIG. 2 is merely given as a standard.)

The case where the load current is extremely large, e.g., during communication by a portable telephone (a and b in FIG. 2).

in this case, it is menaced with a shortage of a current only from the secondary battery 1 regardless of whether the secondary battery 1 is in a charged state or in a discharged state. Therefore, the switching circuit is turned on to supply power to the load circuit from both of the fuel cell 4 and the secondary battery 1.

The case where the load current is large during communication by a portable telephone (c and d in FIG. 2):

In this case, when the secondary battery 1 approximates to a fully charged state, a sufficient current is supplied only from the secondary battery 1. The switching circuit is turned off to suspend power supply from the fuel cell 4. Conversely, when the secondary battery 1 approaches a discharged state, it is threatened with a shortage of a current only from the secondary battery 1. Therefore, the switching circuit is turned on to supply power to the load circuit from both of the fuel cell 4 and the secondary battery 1.

The case where the load current is small during communication by a portable telephone (e and f in FIG. 2):

In this case, when the secondary battery 1 approximates to a fully charged state, a sufficient current is supplied only from the secondary battery 1. The switching circuit is turned off to suspend power supply from the fuel cell 4. Conversely, when the secondary battery 1 approaches a discharged state, it is threatened with a shortage of a current only from the secondary battery 1. Therefore, the switching circuit is turned on to supply power from the fuel cell 4 to the load circuit, and excess power is accumulated in the secondary battery 1.

The operation of the solar cell in the case where a load current is small during communication by a portable telephone (g to i in FIG. 2):

When the secondary battery 1 is in a fully charged state or in a 80% residual state (in a midway state between a fully charged state and a discharged state), power generated by the solar cell 2 is not supplied to the secondary battery 1 despite of the state of the solar cell 2 (exposed to the direct rays of the sun or in the shade). Conversely, when the secondary battery 1 approximates to a discharged state, if the solar cell 2 is generating electricity, the generated power is supplied to the secondary battery 1 and accumulated therein regardless of whether the load current is large or small.

The operation of the switch-controlling circuit 6 of the power-supply unit shown in FIG. 1, which meets the ON/OFF control conditions of the switching circuit, shown in FIG. 2, will be described below.

Assume, as the setting conditions of the power-supply unit, that a lithium secondary battery is used for the secondary battery 1, and that the second battery is in a fully charged state when charging voltage amounts to 4.2 V. Moreover suppose that the batter is in a 80% residual state when the charging voltage is 4.1 V and is in a discharged state when the charging voltage is less than 4.0 V. In consideration of these setting conditions, assume that generating voltage of the fuel cell 4 is 4.2 V.

In the ON/OFF control conditions of the switching circuit, shown in FIG. 2 the switching circuit is turned off in the 1-4th conditions, starting from higher voltage whereas the switching circuit is turned on in the 5-9th conditions. It is seen from this that a border line between the on/off control is between the 4th and the 5th conditions, starting from higher voltage of the secondary battery side. The voltage of the secondary battery side, in the 4th condition, is 4.1 V in a 80% residual state. It is seen from this that even 4 in case h and 5 in case a, the voltage thereof varies due to the load current. When the load current is extremely large, voltage on the secondary battery side in cases a,h might be 4,6. Presume that, when voltage at point A of the switch controlling circuit 6 shown in FIG. 1 is less than 4.1 V, the switching circuit is turned on. In consideration of these conditions, assume that when voltage at point A of the switch-controlling circuit 6 shown in FIG. 1 is 4.1 V or more, the transistor 11 is turned on, and when the voltage is less than 4.1 V, the transistor 11 and resistors 7,8 are set such that the transistor 11 is turned on. Further, suppose that when voltage at point E of the switch-controlling circuit 6 is 4.1 V or more, the transistor 12 is turned on, and when the voltage is less than 4.1 V, the transistor 12 and resistors 9,10 are set such that the transistor 12 is turned on.

The case where the load current is extremely large (a and b in FIG. 2):

Referring to FIG. 1, when the load current is extremely large, regardless of whether the secondary battery 1 is in a charged state or in a discharged state, voltage at point A becomes less than 4.1 V, and the transistor 11 is turned off. Therefore, a path extending from point C to the ground through the transistor 11 is cut off. When voltage of 4.2 V generated by the fuel cell 4 is applied to point Et, the transistor 12 turns off, and an electric potential of point D drops. The PchFET 5 is turned on to supply power from the fuel cell 4 to the load circuit.

The case where the load current is large or small and the secondary battery 1 approaches a discharged state (d, f, and in FIG. 2):

In this case, voltage at point A becomes less than 4.1 V, and the PchFET 5 is turned on as with the case where the load current is extremely large, thus supplying power from the fuel cell 4 to the load circuit.

The case where the load current is large or small and the secondary battery 1 approximates to a fully charged state (c, e, g, and h in FIG. 2):

In this case, voltage at point A becomes 4.1 V or more, and the transistor 11 turns on. Thus, a path extending from point C to the ground through the transistor 11 is conducted. Even though voltage of 4.2 V generated by the fuel cell 4 is applied to point E, an electric potential of point C drops and the transistor 12 turns off, and an electric potential of point D rises and the PchFET 5 is tuned off, thus cutting off power from the fuel cell 4 to the load circuit. Instead, it may be arranged that the fuel cell 4 be automatically deactivated by turning off the PchFET 5, or otherwise that the fuel cell 4 be automatically activated to bring voltage at point A into being less than 4.1 V, i.e., by turning off the transistor 11.

The setting conditions of the solar cell 2 of the power-unit shown in FIG. 1, which meet the operations of the solar cell 2, shown in FIG. 2 will next be described below.

Because the secondary battery 1 is in an 80% residual state when its charging voltage is 4.1 V the voltage generated by the solar cell 2 is set to 4.1 V. By setting in this way, when the secondary battery 1 approaches a discharged state, the power generated by the solar cell 2 can be supplied to the secondary battery 1 to charge the battery 1, as far as the solar cell 2 is generating electricity, regardless of whether the load current is large or small.

Remark parenthetically, the diode 3 can prevent a backflow of current from the secondary battery 1 or the load circuit to the solar cell 2 when the solar cell 2 is not generating electricity as it is in the shade.

The operation of the backflow-preventing circuit 14 of the power-supply unit shown in FIG. 1 will next be described below.

The backflow-preventing circuit 14 is provided for preventing a backflow of current from the secondary battery 1 side or the load circuit side to the fuel cell 4. That is, as shown in FIG. 1, the backflow-preventing circuit is for detecting the voltages of point F and point J, and turning off the PchFET 15 to break the circuit when the voltage of point F exceeds the voltage of point J.

In other words, a constant current circuit 22 is connected between an emitter of the transistors 20, 21 and the ground. Therefore, when the voltage of point F exceeds the voltage of point J, the voltage of node G between the resistors 16, 17 dividing the voltage of point F builds up, increasing a current flowing in to the constant current circuit 22 via the transistor 20. As a result, the current, flowing in the constant current circuit 22 via the resistor 23 and the transistor 21, decreases building up the voltage of point I and the PchFET 15 is turned off to break the circuit.

Meanwhile, when the voltage of point J builds up, the voltage of point H to be divided by the resistors 18, 19 builds up, increasing the current flowing in the constant current circuit 22 via the resistor 23 and the transistor 21. At this moment, a decreased current flows in the constant current circuit 22 via the transistor 20. Consequently, an increased voltage drop occurs at the resistor 23, thus dropping the voltage of point I and the PchFET 15 is turned on.

Thus, the backflow-preventing circuit 14 operates to prevent a backflow of current from the secondary battery 1 side or the load circuit side to the fuel cell 4; however, regulation of their resistance values and a variety of parameters enable adjustment of a relationship of the voltage between point F and point J, which is concerned in an on/off control of the PchFET 15.

Say in passing, in the first embodiment, a variety of conditions are set; however, an arbitrary value may be set thereto.

As described above, according to the first embodiment, it attains a fine control of the power source supply from the secondary battery 1 and the fuel cell 4 to the load circuit according to how large load current is applied to the load circuit and whether the secondary battery 1 is in a charged state or in a discharged state.

Further, since the first embodiment can get along without a power converter converting between a direct current and an alternating current, it prevents the secondary battery 1 from being broken due to a ripple or the like.

Furthermore, even when the load current is large, a connection is provided between the fuel cell 4 and the secondary battery 1 by turning on the PchFET 5, supplying power generated by the fuel cell 4 to the load circuit as well as charging the secondary battery 1 when occasion demands. This saves the time to be taken for charging the secondary battery 1 under a light load.

Moreover, when the load current is large, power can be supplied from both of the fuel cell 4 and the secondary battery 1 to the load circuit by turning on the PchFET 5, thereby reducing an electrical capacity of the secondary battery 1.

Still further, a circuit configuration of the switch-controlling circuit 6 can be simplified by tuning on/off the PchFET 5 according to the voltage detected by the accumulating-means side voltage-detecting circuit composed of the resistors 7, 8

Still furthers the PchFET 5 can be more finely controlled by turning on/off the PchFET 5 according to the voltage detected by the accumulating-means side voltage-detecting circuit composed of the resistors 7, 8 and the fuel-cell side voltage-detecting circuit composed of the resistors 9, 10.

Still further, when the load current to the load circuit is extremely large, power can be supplied from both of the fuel cell 4 and the secondary battery 1 to the load circuit by turning on the PchFET 5 and reducing an electrical capacity of the secondary battery 1. In particular, a remarkable effect can be exerted when the power-supply unit is applied to a circuit instantaneously requiring a peak current, as with the case of rotating a sel-motor of a motor vehicle or its equivalent.

Still further, when a load current applied to the load circuit is large and the secondary battery 1 is in a fully charged state, the PchFET 5 is turned off, and when the load current to the load circuit is large and the secondary battery 1 is in a discharged state, the PchFET 5 is turned on. Thus, when the secondary battery 1 is in a fully charged state, sufficient power can be supplied thereto only from the secondary battery 1, the PchFET 5e is turned off and the fuel cell 4 is deactivated to save the energy. Conversely, when the secondary battery 1 is in a discharged state, the PchFET 5 is turned on, thus supplying power to the load circuit from both of the fuel cell 4 and the secondary battery 1.

Still further, when the load current to the load circuit is small and the secondary battery 1 is in a fully charged state, the PchFET 5 is turned off, and when the load current to the load circuit is small and the secondary battery 1 is in a discharged state, the PchFET 5 is turned on. Thus, when the secondary battery 1 is in a fully charged state, sufficient power can be supplied thereto only from the secondary battery 1, the PchFET 5 is turned off and the fuel cell 4 is deactivated to save the energy. Conversely, when the secondary battery 1 is in a discharged state, the PchFET 5 is turned on, thus supplying sufficient power to the load circuit from both of the fuel cell 4 and charging the secondary battery 1.

Still further, since the fuel cell 4 is connected to the secondary battery 1 through the backflow-preventing circuit 14, it prevents a backflow of the current to the fuel cell 4 from the secondary battery 1 or the load circuit when an electric potential of the secondary battery 1 side or the load circuit side is higher than that of the fuel cell 4.

Yet further, the solar cell 2 is connected to the secondary battery 1, thus supplying power generated by the solar cell 2 to the load circuit when the solar cell 2 is exposed to the direct rays of the sun.

Yet further, when the secondary battery 1 is in a discharged state, a power generated by the solar cell 2 is charged in the secondary battery 1, thus charging the power generated by the solar cell 2 in the secondary battery 1 when the secondary battery 1 is in a discharged state.

Yet further, since the solar cell is connected to the secondary battery 1 via the diode 3, it prevents a backflow of current from the secondary battery 1 or the load circuit to the solar cell 2 when the solar cell 2 is not generating electricity as it is in the shade. Further, composing the backflow-preventing circuit 14 with a diode 3 simplifies its circuit configuration.

In FIG. 1 descriptions of the fuel cell 4 secondary battery 1, solar cell 2, switch-controlling circuit 6, switching circuit 5, and reverse-current preventing circuit have been got on based on the positive voltage with respect to the ground (a zero potential). Instead, not limited thereto, even when configuring the circuit where the load is negative voltage, and a reference point of each circuit is the ground, the operating principle is the same, though it is required that NPN transistors used for the circuits 14, 6, and 5 be replaced with PNP transistors, and the P channel transistors be replaced with N channel transistors.

### Second Embodiment

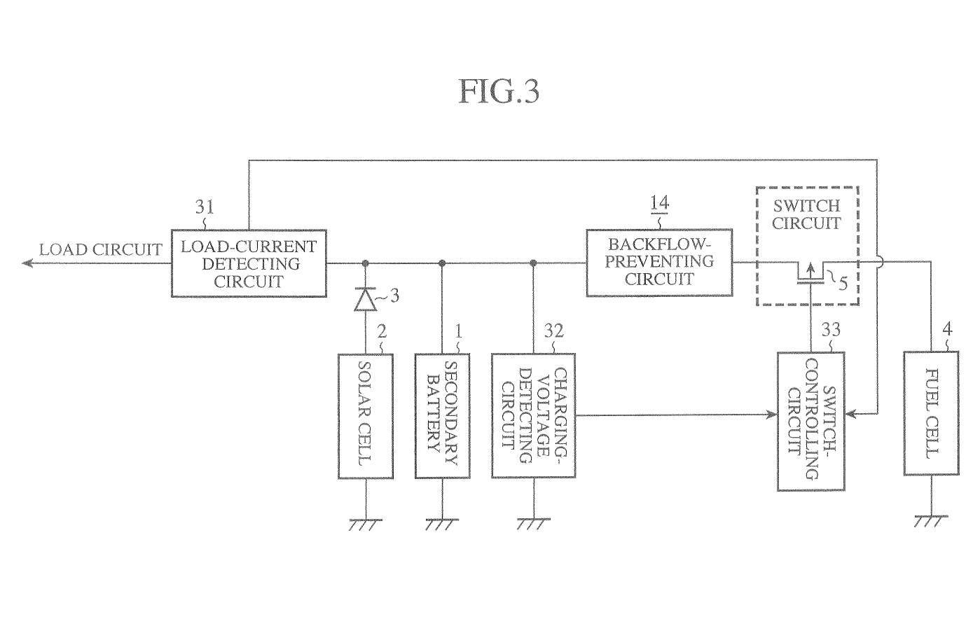

FIG. 3 is a circuit diagram showing a power-supply unit according to the second embodiment of the present invention. Referring to FIG. 3, a load-current detecting circuit 31 is connected to the load circuit side as compared with the secondary battery 1 and the solar cell 2, and the load-current detecting circuit is for detecting haw large load current is applied to the load circuit. A charging-voltage detecting circuit 32 is connected to both ends of the secondary battery 1, and is for detecting charging voltage of the secondary battery 1. A switch-controlling circuit 33 is for on/off controlling the PchFET 5 according to how large load current is applied to the load circuit detected by the load-current detecting circuit 31 and the charging voltage of the secondary battery 1 detected by the charging-voltage detecting circuit 32. The other arrangement is similar to that shown in FIG. 1, and an explanation thereof is omitted for economy of space.

The operation of the second embodiment will now be described below.

In the power-supply unit shown in FIG. 1, the ON/OFF control conditions of the switching circuit shown in FIG. 2 are controlled according to the voltages of points A and E of the switch-controlling circuit 6. Unlike the first embodiment, in the power-supply unit according to the second embodiment shown in FIG. 3, the ON/OFF control conditions of the switching circuit shown in FIG. 2 are controlled according to how large load current is applied to the load circuit detected by the load-current detecting circuit 31 and the charging voltage of the secondary battery 1 detected by the charging-voltage detecting circuit 32

For example, in the switch-controlling circuit 33, a threshold is set to the magnitude of the load current, and the magnitude of the load current to the load circuit detected by the load-current detecting circuit 31 is judged to determine under which case the load current falls: the case where the load current to the load circuit is extremely large, the case where the load current is large, and the case where the load current is small. Moreover, a threshold is set to the charging voltage of the secondary battery 1. For example, it is taken as a fully charged state in the case where the charging voltage is 4.1 V or more, and as a discharged state in the case where the charging voltage is less than 4.1 V. The charging voltage of the secondary battery 1 detected by the charging-voltage detecting circuit 32 is judged to determine under which state the charging voltage falls: the fully charged state or the discharged state. In addition, the switch-controlling circuit 33 on/off controls the PchFET 5 based on the ON/OFF control conditions of the switch circuit shown in FIG. 2, according to a combination of the magnitude of the large load current to the load circuit and the charging voltage of the secondary battery 1.

Alternatively, the switch-controlling circuit 33 may on/off control the PchFET 5 by making a judgment with an electric circuit (hardware) according to the combination of the magnitude of the large load current to the load circuit and the charging voltage of the secondary battery 1, or may on/off control the PchFET 5 by making a judgment with software.

As mentioned above, according to the second embodiments the PchFET 5 is tuned on/off according to how large load current is applied to the load circuit detected by the load-current detecting circuit 31 and the charging voltage of the secondary battery 1 detected by the charging-voltage detecting circuit 32, thus finely controlling power source supply to the load circuit from the secondary battery 1 and the fuel.

Descriptions of the operation according to the second embodiment shown in FIG. 3 have been got on mainly focusing on the positive voltage as with FIG. 1. Not limited thereto, even in case of using negative voltage, a circuit can be configured on the same principle as the positive voltage.

### Third Embodiment

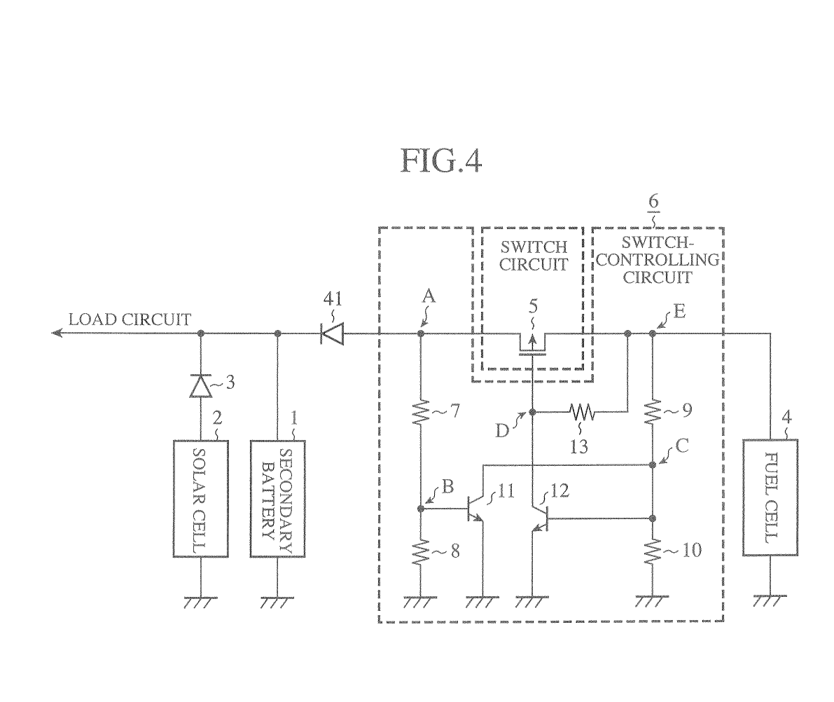

FIG. 4 is a circuit diagram showing a power-supply unit according to the third embodiment of the present invention. Referring to FIG. 4, an anode of a diode (first backflow-preventing circuit) 41 is connected to the fuel cell 4 side and a cathode thereof is connected to the secondary battery 1 side and the load circuit side, and is for preventing a backflow of current from the secondary battery 1 and the load circuit to the fuel cell 4. The other arrangement is similar to that shown in FIG. 1, and an explanation thereof is omitted for economy of space.

The operation of the third embodiment will now be described below.

In the power-supply unit shown in FIG. 1, a backflow of current from the secondary battery 1 and the load circuit to the fuel cell 4 is prevented by the backflow preventing circuit 14. Unlike the first embodiment, in the third embodiment, a diode 41 plays a similar role to the backflow preventing circuit 14.

As described above, according to the third embodiment, when an electric potential of the secondary battery 1 side or the load circuit side is higher than that of the fuel cell 4, the third embodiment prevents a backflow of current to the fuel cell 4 from the secondary battery 1 or the load circuit. Especially, the diode 41 conduces to simplification of the circuit configuration.

### Fourth Embodiment

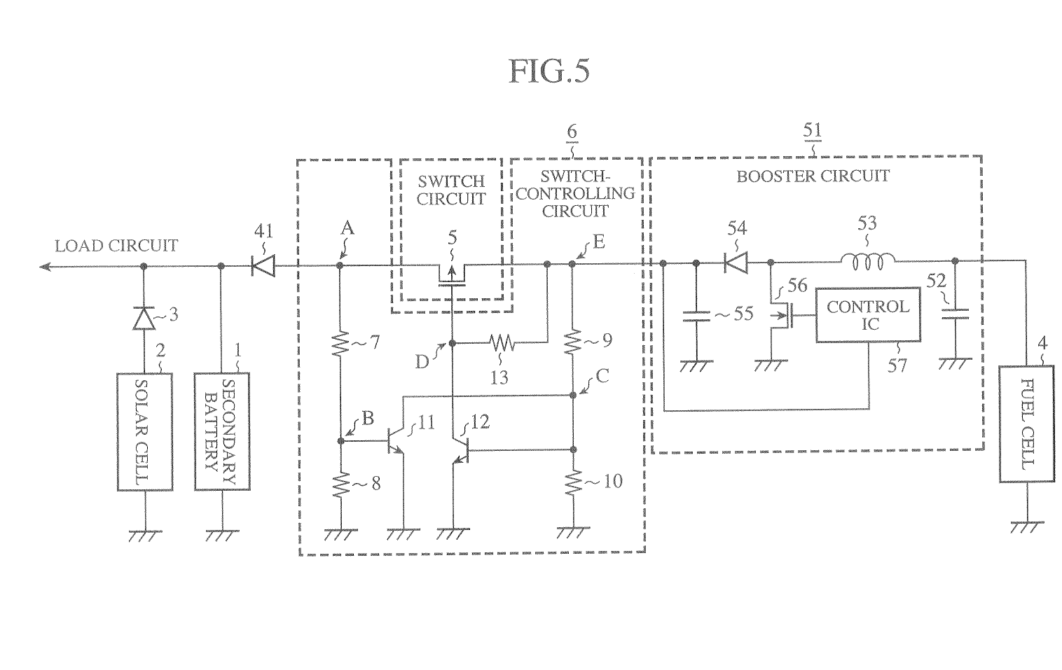

FIG. 5 is a circuit diagram showing a power-supply unit according to the fourth embodiment of the present invention. Referring to FIG. 5, a booster circuit 51 is provided between the fuel cell 4 and the PchFET 5, and is for boosting voltage generated by the fuel cell 4. In the booster circuit 51, a capacitor 52 is connected in parallel to an output path of the fuel cell 4, and a coil 53 is connected in series to the output path of the fuel cell 4. A diode 54 is connected in series to the output path of the fuel cell 4, and a capacitor 55 is connected in parallel to the output path of the fuel cell 4, these diode 54 and capacitor 55 constituting a smoothing circuit. An NchFET 56 is connected in parallel between the coil 53 and the diode 54 of the output path of the fuel cell 4, and a control IC 57 is for on/off controlling the NchFET 56 in a cycle according to output voltage of the smoothing circuit. The other arrangement thereof is similar to that shown in FIG. 4, and an explanation thereof is omitted for economy of space.

The operation of the fourth embodiment will now be described below.

In the power-supply units shown in FIG. 1, FIG. 3, and FIG. 4, although the fuel cell 4 generates more higher voltage than the charging voltage of the secondary battery 1, the voltage generated by the fuel cell 4 might drop due to an internal impedance of the fuel cell 4 when charging the secondary battery 1 from the fuel cell 4. In such a case, as shown in FIG. 5, the booster circuit 51 is provided between the fuel cell 4 and the PchFET 5 so as to boost by the booster circuit 51 the voltage generated by the fuel cell 4, and perform a function of supplying power to the load circuit or of charging the secondary battery 1.

The voltage generated by the fuel cell 4 is accumulated in the capacitor 52, and in the capacitor 55 through the coil 53 and the diode 54. The control IC 57 detects charging voltage of the capacitor 55, and when the charging voltage dropped, e.g. from 4.2 V to 4.1 V under normal conditions the control IC ON/OFF controls the NchFET 56. A cycle of the ON/OFF control is set such that the less the detected voltage is low the more a duty ratio increases. An ON control of the NchFET 56 forms a closed circuit extending from the fuel cell 4 and the capacitor 52 to the coil 53 and the NchFET 56, and an electric energy generated by the fuel cell 4 and the capacitor 52 is accumulated in the coil 53. The on/off control of the NchFET 56 causes the coil 53 to generate voltage, including a ripple to which the charging voltage of the capacitor 52 is added to the voltage generated by the fuel cell 4. The voltage including the ripple is smoothed by the smoothing circuit composed of the diode 54 and the capacitor 55 to generate voltage of 4.2 V under normal conditions.

In the fourth embodiment, the voltage generated by the fuel cell 4 is set to 4.2V under normal conditions in conformity with portable telephones and personal computers. Instead, not limited thereto, plural fuel cells 4 and secondary batteries 1 may be connected in series, and the fourth embodiment is applicable to the case where the load is a motor vehicle or its equivalent.

As mentioned above, according to the fourth embodiment, the booster circuit 51 for boosting the voltage generated by the fuel cell 4 is provided. Accordingly, although the voltage generated by the fuel cell 4 is higher than the charging voltage of the secondary battery 1, when the voltage generated by the fuel cell 4 dropped due to an internal impedance of the fuel cell 4 at the time of charging the secondary battery 1 from the fuel cell 4, the booster circuit 51 can boost the voltage generated by the fuel cell 4, thus carrying out a function of supplying power to the load circuit or of charging the secondary battery 1.

### Fifth Embodiment

The fifth embodiment uses, e.g., a large super-capacitor having a capacitance of 4000 μF or more in place of the secondary battery 1 in the first embodiment to the forth embodiment described above. Since there can be a super-capacitor having an impedance lower than that of a lithium secondary battery or the like in some instances, the super-capacitor is advantageous to a device demanding a heavy current during starting in that a large amount of current can instantaneously be drawn in.

As described in the first embodiment, in motor vehicles (gasoline-fueled vehicles) or the like, once the sel-motor is rotated, electricity is generated with gasoline afterward. As the vehicle requires a large amount of current only at the time of rotating the sel-motor, the energy accumulated in the super-capacitor is devoted to draw the heavy current.

As mentioned above, according to the fifth embodiment, the super-capacitor is employed as the secondary battery 1. Thus, a remarkable effect can be obtained when the present invention is applied particularly to a circuit instantaneously demanding a peak current such as a circuit rotating the sel-motor of a motor vehicle or its equivalent, for its large capacitance in comparison with a capacitor.

### INDUSTRIAL APPLICABILITY

As stated above, the power-supply unit according to the present invention is suitable for use in large wireless receivers, electric-power storing batteries, uninterruptible power-supplying systems, gasoline-fueled vehicles, electric vehicles, personal computers, portable telephones, and their equivalent.

1. A power-supply unit comprising:
a chargeable accumulating means connected to a load circuit;
a fuel cell connected to the accumulating means through a switching circuit; and
a switch-controlling circuit on/off controlling the switching circuit according to how large load current is applied to the load circuit and whether the accumulating means is in a charged state or in a discharged state.

2. The power-supply unit according to claim 1, wherein the switch-controlling circuit comprises an accumulating-means side voltage-detecting circuit detecting voltage of the accumulating means side rather than the switching circuit, and
the switch-controlling circuit on/off controls the switching circuit according to the voltage detected by the accumulating-means side voltage-detecting circuit.

3. The power-supply unit according to claim 1, wherein the switch-controlling circuit comprises:
the accumulating-means side voltage-detecting circuit detecting voltage of the accumulating means side rather than the switching circuit; and
a fuel-cell side voltage-detecting circuit detecting voltage of the fuel cell side rather than the switching circuit; and
the switch-controlling circuit on/off controls the switching circuit according to the voltages detected by the accumulating-means side voltage-detecting circuit and the fuel-cell side voltage-detecting circuit.

4. The power-supply unit according to claim 1, further comprising a load-current detecting circuit detecting how large load current is applied to the load circuit and a charging-voltage detecting circuit detecting charging voltage of the accumulating means,
wherein the switch-controlling circuit on/off controls the switching circuit according to how large load current is applied to the load circuit detected by the load-current detecting circuit and charging voltage of the accumulating means detected by the charging-voltage detecting circuit.

5. The power-supply unit according to claim 1, wherein the switch-controlling circuit classifies the load current into the case where the load current to the load circuit is extremely large, the case where the load current is large, and the case where the load current is small, and the switch-controlling circuit ON controls the switching circuit when the load current to the load circuit is extremely large.

6. The power-supply unit according to claim 1, wherein the switch-controlling circuit classifies the load current into the case where the load current to the load circuit is extremely large, the case where the load current is large, and the case where the load current is small; the switch-controlling circuit OFF control ling the switching circuit when the load current to the load circuit is large and the accumulating means is in a fully charged stage and ON controlling the switching circuit when the load current to the load circuit is large and the accumulating means is in a discharged stage.

7. The power-supply unit according to claim 1, wherein the switch-controlling circuit classifies the load current into the case where the load current to the load circuit is extremely large, the case where the load current is large, and the case where the load current is small; the switch-controlling circuit OFF controlling the switching circuit when the load current to the load circuit is small and the accumulating means is in a fully charged stage; and ON controlling the switching circuit when the load current to the load circuit is small and further, the accumulating means is in a discharged stage.

8. The power-supply unit according to claim 1, wherein the fuel cell is connected to the accumulating means through a first backflow-preventing circuit preventing a backflow of current from the accumulating means or the load circuit to the fuel cell.

9. The power-supply unit according to claim 8, wherein the first backflow-preventing circuit is a diode.

10. The power-supply unit according to claim 1, further comprising a solar cell connected to the accumulating means.

11. The power-supply unit according to claim 10, wherein the solar cell charges power in the accumulating means generated by the solar cell when the accumulating means is in a discharged state.

12. The power-supply unit according to claim 10, wherein the solar cell is connected to the accumulating means through a second backflow-preventing circuit preventing a backflow of current from the accumulating means or the load circuit to the solar cell.

13. The power-supply unit according to claim 12, wherein the second backflow-preventing circuit is a diode.

14. The power-supply unit according to claim 1, further comprising a booster circuit boosting the voltage generated by the fuel cell, between the fuel cell and the switching circuit.

15. The power-supply unit according to claim 1, wherein the accumulating means is a secondary battery.

16. The power-supply unit according to claim 1, wherein the accumulating means is a capacitor.

17. The power-supply unit according to claim 1 wherein the accumulating means is a super-capacitor.
